(19) United States
(12) Patent Application Publication
(10) Pub. No.: US 2005/0182719 A1
(43) Pub. Date: Aug. 18, 2005

(54) Method and system for automated traffic citation payment and processing

(76) Inventor: Matthew Lee Withrow, Midland, TX (US)

Correspondence Address: FORTKORT GRETHER + KELTON LLP, 8911 N. CAPITAL OF TEXAS HWY., SUITE 3200, AUSTIN, TX, 78759, US

(21) Appl. No.: 10/780,479

(22) Filed: Feb. 17, 2004

(51) Int. Cl. G06F 17/60

(52) U.S. Cl. 705/40

(57) ABSTRACT

A method and system for settling a parking citation provides an on-line parking citation interface to a user. The invention connects the on-line parking citation interface to a receiving application for receiving a predetermined minimal set of information relating to a parking citation. The method and system then connect the receiving application to a polling application for interfacing with a parking citation issuing authority. Communicating the predetermined minimal set of information with the parking citation issuing authority in an information protocol usable by the parking citation issuing authority also occurs with the invention. Then, the invention identifies a parking citation from the parking citation issuing authority associated with the minimal set of information. Having identified a parking citation, the method and system permit electronically transferring funds at, the direction of the user, from a predetermined electronic funds source to an electronic account associated with the parking citation issuing authority for settling the parking citation.

### FIELD OF THE INVENTION

This invention pertains to a method and system for automated traffic citation payment and processing, and, more particularly, to an on-line system method for the settlement of parking tickets and similar citations issuing from a university, municipality, or similar issuing authority.

### BACKGROUND OF THE INVENTION

Traffic and parking management presents an array of complex challenges. Managing databases, issuing permits, writing tickets, collecting payments, and scheduling clerical support are a few of the issues that arise. At present, there is no known way to pay a parking ticket for streamlining the exchange of ticket information and payment processing.

Further problems associated with known methods and systems for settling traffic and parking citations from a university or similar issuing authority, include the need for a system that permits streamlined electronic transaction certification and authorization. As such, existing ways of settling traffic and parking citations involve the problems of waiting in line for a clerk to service the payor, as well as oftentimes repeated trips to a parking or municipal office for settling the dispute. Still further, existing processes involve numerous envelopes and paperwork for managing the settlement process. As such, the traffic or parking citation settlement process is labor-intensive, inefficient process in dire need of improvement.

### BRIEF DESCRIPTION OF THE DRAWINGS

For a more complete understanding of the traffic citation settlement system and advantages thereof, reference is now made to the following description which is to be taken in conjunction with the accompanying drawings and in which like reference numbers indicate like features and further wherein:

FIG. 1 provides one example of a computer system that employ the traffic citation settlement system;

FIG. 2 shows a logical diagram illustrating the proposed traffic parking citation processing environment of the traffic citation settlement system;

FIG. 3 shows a polling application package diagram for use with the traffic citation settlement system;

FIG. 4 illustrates the polling and receiving application architecture of the traffic citation settlement system;

FIG. 5 details the process flow relating to parking citation payment process of the traffic citation settlement system;

FIG. 6 shows the initial flowchart for the overall administration processes of the preset invention;

FIG. 7 shows a flowchart of the logic of the administrative portion for adding a university hyperlink;

FIG. 8 shows a flowchart of the logic associated with the search for university hyperlink appearing on administration main menu screen;

FIG. 9 shows a process flow relating to the addition of an advertisement hyperlink;

FIG. 10 illustrates a process flow of the administration process in response to a search by the administrator for advertisements;

FIG. 11 depicts the process flow of the traffic citation settlement system in response to the administration of a university detailed transaction hyperlink being clicked;

FIG. 12 depicts the process flow of the traffic citation settlement system in response to the administration of a university summary transaction hyperlink being clicked;

FIG. 13 shows an example of the storefront package diagram consistent with the teachings of the traffic citation settlement system;

FIG. 14 shows the class diagram of the business package package classes according to the traffic citation settlement system;

FIG. 15 provides the class diagram of the service package classes according to the teachings of the traffic citation settlement system;

FIG. 16 provides the class diagram for the exceptions package classes according to the teachings of the traffic citation settlement system;

FIG. 17 shows a base framework classes used by the storefront action classes of the traffic citation settlement system;

FIG. 18 shows the classes which form the framework classes that handle the citation display, selection, and procesing within the traffic citation settlement system;

FIG. 19 shows the framework classes of the traffic citation settlement system for handling citation payment information display and processing;

FIG. 20 shows the framework classes used to handle the citation purchase information display processing of the traffic citation settlement system;

FIG. 21 shows the framework classes that are used to handle citation purchasers confirmation display processing;

FIG. 22 shows the UML and package and class diagram relationships that support the administration recording requirements of the traffic citation payment system of the traffic citation settlement system;

FIG. 23 illustrates the class diagram for the business object package classes;

FIG. 24 shows the advertisement package classes associated with other package classes;

FIG. 25 shows the class diagram for the framework package classes;

FIG. 26 shows the class diagram for the framework utility sub package classes;

FIG. 27 is the class diagram for the payment sub package;

FIG. 28 includes class diagrams for the framework view sub package classes;

FIG. 29 presents the class diagram for the framework exceptions sub package classes;

FIG. 30 presents the class diagram for the general package classes;

FIG. 31 shows the class diagram for the security package classes;

FIG. 32 includes the various classes in the collection of delegate access design pattern classes;

FIG. 33 presents university package classes demonstrated association with other package classes; and

FIG. 34 shows the class diagram for the traffic payment user package.

### DETAILED DESCRIPTION OF THE INVENTION

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

According to another aspect of the traffic citation settlement system, there is provided a method and system for settling a parking citation that includes the steps and associated instructions for providing an on-line parking citation interface to a user. The invention connects the on-line parking citation interface to a receiving application for receiving a predetermined minimal set of information relating to a parking citation. Then, the method and system connect the receiving application to a polling application for interfacing with a parking citation issuing authority. Communicating the predetermined minimal set of information with the parking citation issuing authority in an information protocol that usable by the parking citation issuing authority also occurs with the present system. The traffic citation settlement system, furthermore, identifies a parking citation from the parking citation issuing authority associated with the minimal set of information. Electronically transferring funds at the direction of the user from a predetermined electronic funds source to an electronic account associated with said parking citation issuing authority for settling said parking citation also occurs with the present invention.

The present citation payment system and method provide a preferred method of payment for parking and traffic violations in the continental United States by providing fast, reliable, and secure on-line transactions with an ongoing commitment to expansion into new markets while remaining the leader in our industry. The traffic citation settlement system integrates with any parking management software to help create an unprecedented parking industry standard. This new standard provides a unique ability to integrate with any existing parking management software of the issuing authority.

The traffic citation settlement system is the ability to tackle all of the complex issues associated with providing an on-line payment solution. The traffic citation settlement system provides the following: (1) credit card processing (authorization of credit and debit cards); (2) setup of merchant accounts; (3) the ability to pay tickets via credit or debit cards; (4) an email receipt and confirmation number; (4) the ability to check the status of a ticket on-line; (5) a fast and convenient method of resolving traffic and parking tickets; (6) no unwanted trips to the parking or municipal office; (7) no need to keep up with envelopes or addresses; (8) no more valuable time lost in already overloaded schedules; (9) a web portal to support the citation settlement transaction; (10) a toll-free number for users who are not comfortable with on-line transactions; (11) a simple interface to existing parking management software; (12) a streamlined exchange of ticket and payment data between the issuing authority and the present citation payment system and method; (13) higher collection rates on tickets; (14) higher revenues from parking systems; (15) liability protection from fraudulent transactions; and (16) lower administrative costs.

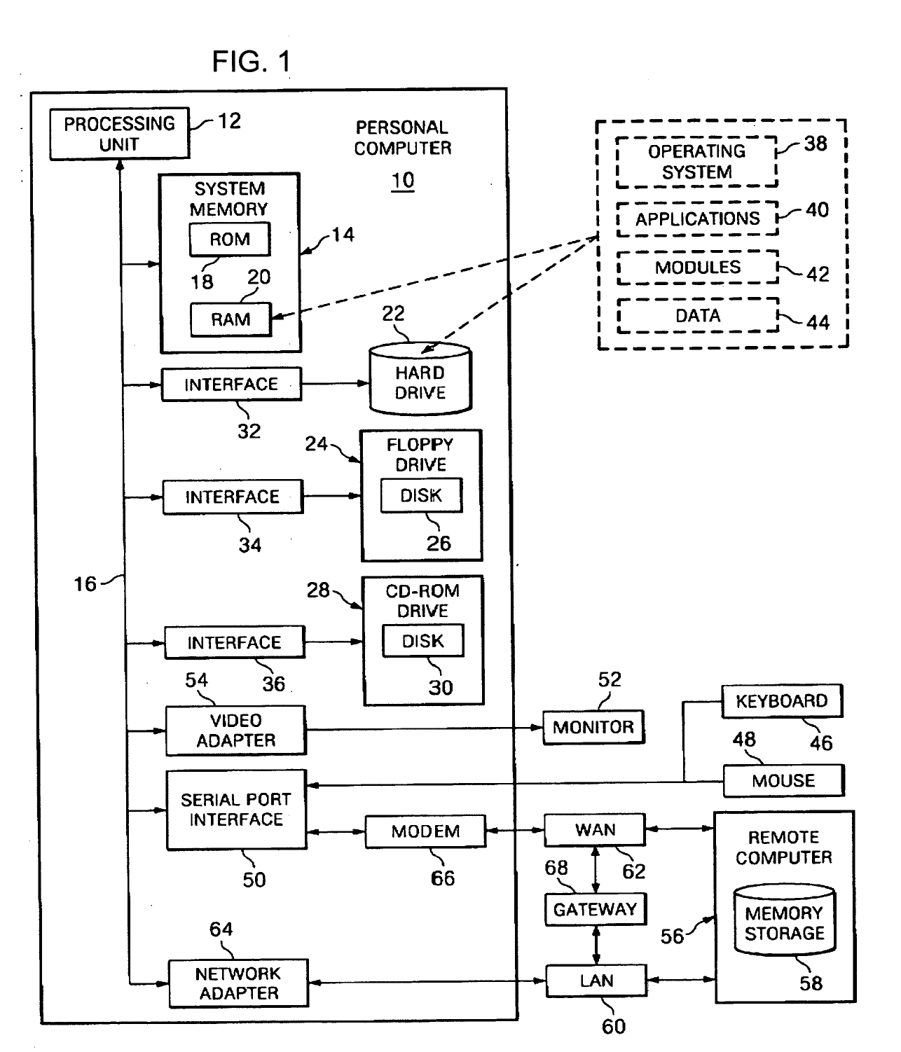

The preferred embodiment of the traffic citation settlement system and its advantages are best understood by referring to FIGS. 1 through 34 of the drawings, like numerals being used for like and corresponding parts of the various drawings. FIG. 1 illustrates a general-purpose computer 10 that may use the automated parking citation settlement method and system of the traffic citation settlement system. General purpose computer 10 may be used as a stand-alone computer or as part of a larger, networked system of personal computers. Using at least two such computers, for example, the traffic citation settlement system makes possible a traffic citation settlement system for fast, economical, settlement of traffic or parking citations from an issuing authority such as a university, a municipality, or the like.

Here, FIG. 1 provides an understanding of how one might use the system of the traffic citation settlement system. General-purpose computer 10 may be used to execute distributed applications and/or distributed and individually operating system services through an operating system. With reference to FIG. 1, an exemplary system for implementing the invention includes a conventional computer 10 (such as personal computers, laptops, and servers), including a processing unit 12, system memory 14, and system bus 16 that couples various system components including system memory 14 to the processing unit 12. Processing unit 12 may be any of various commercially available processors, including Intel x86, Pentium, Inspiron, and compatible microprocessors from Intel and others, including Cyrix, AMD and Nexgen; Alpha from Digital; MIPS from MIPS Technology, NEC, IDT, Siemens, and others; and the PowerPC from IBM and Motorola. Dual microprocessors and other multi-processor architectures also can be used as the processing unit 12.

System bus 16 may be any of several types of bus structure including a memory bus or memory controller, a peripheral bus, and a local bus using any of a variety of conventional bus architectures such as PCI, VESA, AGP, Microchannel, ISA and EISA, to name a few. System memory 14 includes read only memory (ROM) 18 and random access memory (RAM) 20. A basic input/output system (BIOS), containing the basic routines that help to transfer information between elements within the computer 10, such as during start-up, is stored in ROM 18.

Computer 10 further includes a hard disk drive 22, a floppy drive 24, e.g., to read from or write to a removable disk 26, and CD-ROM drive 28, e.g., for reading a CD-ROM disk 30 or to read from or write to other optical media. The hard disk drive 22, floppy drive 24, and CD-ROM drive 28 are connected to the system bus 16 by a hard disk drive interface 32, a floppy drive interface 34, and an optical drive interface 36, respectively. The drives and their associated computer-readable media provide nonvolatile storage of data, data structures, computer-executable instructions, etc. for computer 10. Although the description of computer-readable media provided above refers to a hard disk, a removable floppy and a CD, it should be appreciated by those skilled in the art that other types of media which are readable by a computer, such as magnetic cassettes, flash memory cards, digital video disks, Bernoulli cartridges, and the like, may also be used in the exemplary operating environment.

A number of program modules may be stored in the drives and RAM 20, including an operating system 38, one or more application programs 40, other program modules 42, and program data 44. A user may enter commands and information into the computer 10 through a keyboard 46 and pointing device, such as mouse 48. Other input devices (not shown) may include a microphone, joystick, game pad, satellite dish, scanner, or the like. These and other input devices are often connected to the processing unit 12 through a serial port interface 50 that is coupled to the system bus, but may be connected by other interfaces, such as a parallel port, game port or a universal serial bus (USB). A monitor 52 or other type of display device is also connected to the system bus 16 via an interface, such as a video adapter 54. In addition to the monitor, computers typically include other peripheral output devices (not shown), such as speakers and printers.

Computer 10 may operate in a networked environment using logical connections to one or more remote computers, such as a remote computer 56. Remote computer 56 may be a server, a router, a peer device or other common network node, and typically includes many or all of the elements described relative to the computer 10, although only a memory storage device 58 has been illustrated in FIG. 1. The logical connections depicted in FIG. 1 include a local area network (LAN) 60 and a wide area network (WAN) 62. Such networking environments are commonplace in offices, enterprise-wide computer networks, intranets and the Internet.

When used in a LAN networking environment, the computer 10 is connected to the LAN 60 through a network interface or adapter 64. When used in a WAN networking environment, computer 10 typically includes a modem 66 or other means for establishing communications (e.g., via the LAN 60 and a gateway or proxy server) over the wide area network 62, such as the Internet. Modem 66, which may be internal or external, is connected to the system bus 16 via the serial port interface 50. In a networked environment, program modules depicted relative to the computer 10, or portions thereof, may be stored in the remote memory storage device 58.

It will be appreciated that the network connections shown are exemplary and other means of establishing a communications link between the computers may be used. FIG. 1 only provides one example of a computer that may be used with the invention. The invention may be used in computers other than general-purpose computers, as well as on general-purpose computers without conventional operating systems.

Other aspects, objectives and advantages of the invention will become more apparent from the remainder of the detailed description when taken in conjunction with the accompanying drawings.

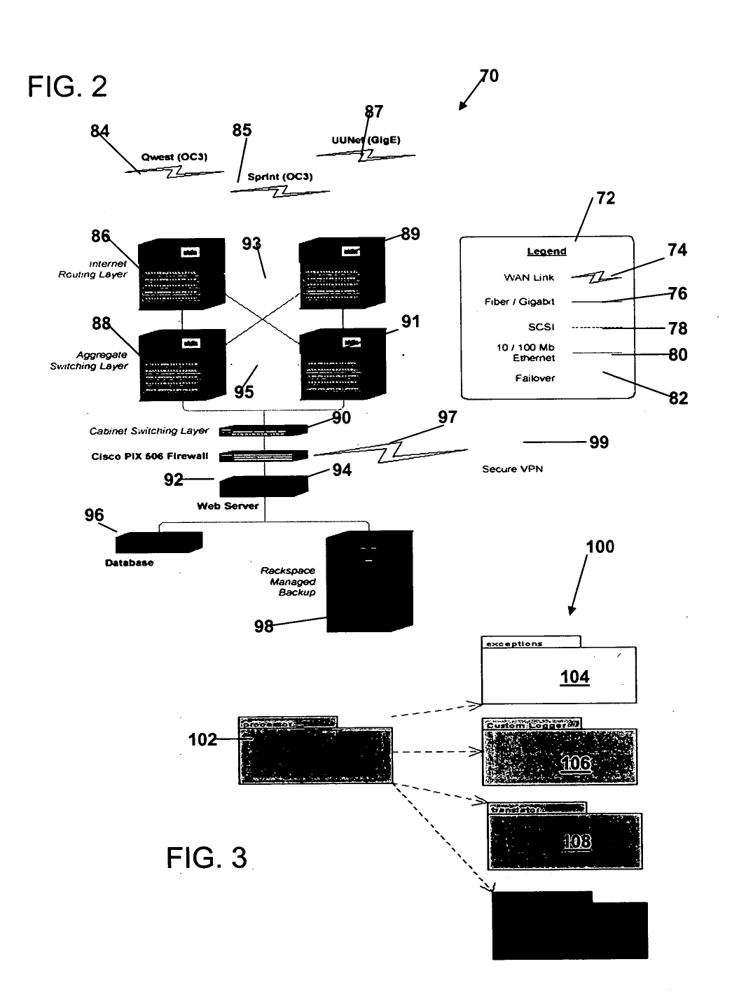

With reference to diagram 70 of FIG. 2, there appears legend 72 indicating the connections within architecture 70 that include a wide area network (WAN) link 74, a fiber or gigabit transport path 76, an SCSI path 78 and Ethernet path 80 and a failover path 82. Thus, within the various WAN link providers of architecture 70 there may be an OC3 connections 84 and 85, as well as Gigabit Ethernet connection 86. Architecture 70 includes an internet routing layer and an aggregate switching layer. Internet routing layer including routers 86 and 89 connecting via connection 93. An aggregate switching layer includes switches 88 and 91 connected via connection 95. Redundancy exists between the service from the routers and switching devices within the respective internet routing layer in aggregate switching layer. Aggregate switching layer of switches 88 and 91 interfaces with cabinet switching layer 90, which passes through the secure VPN firewall layer 92 to web server 94. From web server 94, communications exist between database 96 and racks based managed backup 98.

The traffic citation settlement system and method assures that every party involved in the process of settling the parking citation benefits. In addition to benefiting those paying a citation, the traffic citation settlement system provides a unique benefit of absorbing the costs of accepting credit cards, electronic fund transfers. As such, the traffic citation settlement system provides a far more efficient solution than a traditional mail-in method of payment. In addition to cost-saving features, the traffic citation settlement system provides, on a per transaction basis, the ability for an advertiser to donate money back to the respective university or municipality once the university or municipality achieves certain volume percentages through transactions. Thus, by offering the traffic citation settlement system and method, a citation issuing authority can achieve rapid positive cash flow.

The traffic citation settlement system provides a web application to support the on-line payment of parking citations on behalf of universities. Using the front-end application of the traffic citation settlement system, users will have the ability to select and pay for citations issued by universities and similar issuing authorities for parking violations. In addition to the front-end web application, the traffic citation settlement system provides a citation fulfillment database and an administration web site. The administration web site enables administrators of the traffic citation settlement system to manage universities, advertisements, citation records, as well as to generate reports, pay universities and perform in other administrative actions.

The traffic citation settlement system uses a series of Java Server Pages using the NVC2 Jakarta Struts framework. The traffic citation settlement system may be formed for permitting the selection and payment of parking citations from universities. The programmatic logic of the traffic citation settlement system uses the unified modeling language (UML) and, as the diagrams herein detail, entity relationship diagrams (ERD) for the database design. In one embodiment of the traffic citation settlement system, the hardware on which the method and system may be employed includes a processor, such as the dual Intel Xeon 2.0 GHz processor with 2 GB of DDR RAM using a hard drive a 2×36 GB SCSI drive using a RAID 5 array, and associated software. The traffic citation settlement system may use, on the above described hardware platform, the Windows 2000 Service Pack operating system with the Apache Jakarta-Tomcat web container using Java VM and MVC framework such as the Apache Jakarta Struts framework.

On the database server of the traffic citation settlement system, this functionality may be provided by the servers using a dual Intel Xeon 2.0 GHz processor using a 2 GB DDR RAM with the hard drive of 2×36 GB SCSI drive and a second hard drive of 73 GB SCSI drives. The RAID may be a RAID 1-in-5 array with a failover power supply. In the database server, the operating software may be the Windows 2000 Server operating system with a Server 2000 service pack as the MSS 2L server package. For one embodiment of the traffic citation settlement system, Sun's Java software language may be the application program language for all code that supports the fulfillment of the traffic payment web application.

The Apache Jakarta Struts framework may provide the web application with the ability to enforce a proper separation of functionalities in the site. The Apache Jakarta Struts framework serves as the programming framework for the application. Furthermore, the database server may employ the Microsoft SQL Server 2000 SP3 database platforms further. For the process of building the Java source code, the packaging of the JSP and HTML pages and the execution of unit test the traffic citation settlement system uses the Apache Jakarta ANT 1.5 platform. This is utilized to build and compile Java code and assemble the web application as well as provide a way for unit testing. Moreover, the implementation of the traffic citation settlement system is if the Apache Jakarta ANT 1.5 platform process provides a platform independent, XML-based bill process that is independent of the tools being used to actually create the code.

The traffic citation settlement system uses the Apache Jakarta ANT 1.5 platform. This allows building and compiling Java code and assembling the web application, as well as enabling system testing. Moreover, the implementation of the traffic citation settlement system is if the Apache Jakarta ANT 1.5 platform process provides a platform independent, XML-based bill process that is independent of the tools being used to actually create the code. If the need rises, the modules are available to integrate ANT with a large number of popular development environments in use known in the art. There may be other software programs that are useful with the traffic citation settlement system for testing individual classes within the application, as well as for creating UML class sequence diagrams.

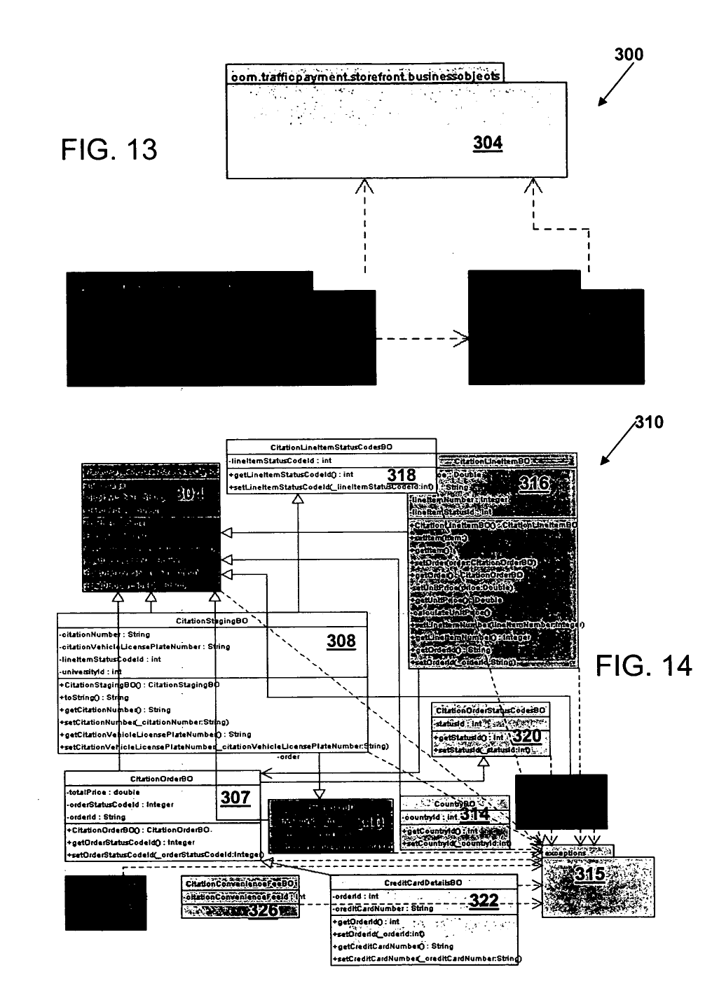

FIG. 3 shows a logical diagram illustrating the proposed traffic parking citation processing environment of the traffic citation settlement system. The traffic citation settlement system uses the unified modeling language (UML) to provide a functional template of requirements for software development. The piece of UML that the traffic citation settlement system employs is the class diagram that provides the database architecture for use in specifying entity relationship diagrams. In the descriptions that follow the class diagram contains methods or operation the attributes or properties that associate with a programmatic class. Class diagrams are broken into three distinct areas, the top area contains the class name, the middle area contains the classes' attributes and the bottom area contains the classes' methods. A plus sign next to an attribute or a method means that this attribute or method is a public method and a negative sign (−) means that the attribute or method is a private method to that class. Once in each of the diagrams the classes have been identified the traffic citation settlement system uses, the following description will then associate the various classes to each other to form a full class diagram. Classes interact with each other through extension, or through instantiations, as described in the following descriptions of FIGS. 13 through 34, which detail their associations and generalizations.

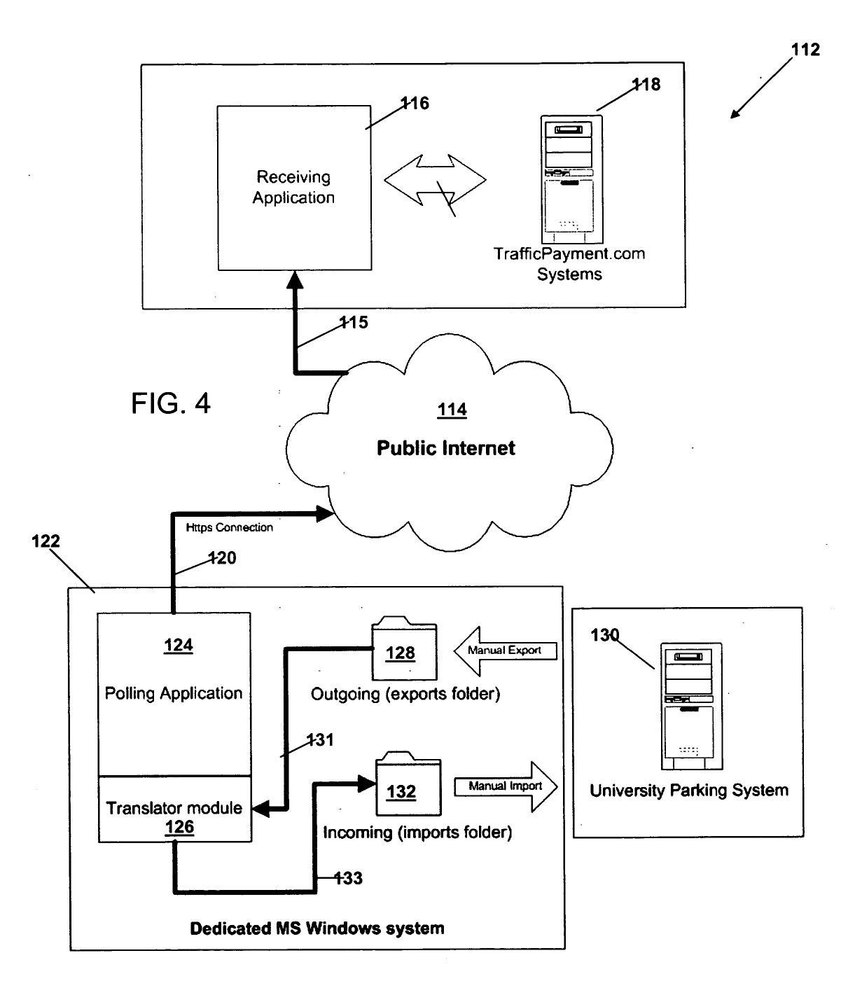

FIG. 3 shows a polling application package diagram 100 for use with the traffic citation settlement system. Polling application package diagram 100 includes processor package 102 which provides input to exceptions package 104, custom logger package 106, translator package 108 and column package 110. With the input from processor package 102, the polling package of the traffic citation settlement system performs the functions associated with polling application 112 of FIG. 4.

FIG. 4, therefore, illustrates the polling application 112 design and implementation for the traffic citation settlement system. Based on polling application 112 requirements of the traffic citation settlement system, the traffic citation settlement system provides a UML package in class diagrams as described in FIG. 4. The traffic citation settlement system provides a UML package and class diagrams with the following attributes. Polling application 112 receives processed citation data from the receiving application and sends citation data to the receiving application for processing. After receiving the citation data from the receiving application, polling application 112 performs the tasks of reading any configuration information from the polling application properties file. The path to the properties file is set up as a system property during system start up. Polling application 112 uses the traffic payment configuration handler to read the properties file. The traffic citation settlement system further translates the XML citation data into the file format that the university may understand. Furthermore, the application archives incoming files and then emails an alias upon critical system failures. The traffic citation settlement system of the polling application may be implemented using a variety of software applications. Furthermore, using various guidelines associated with the polling application, the traffic citation settlement system provides the ability to set up a Java system file path with the value of polling application properties.

FIG. 4 illustrates the polling and receiving application architecture of the traffic citation settlement system. Polling and receiving application logical architecture 112 to include a connection via connection 115 to public internet 114 to receiving application 116 that communicates with the traffic payment system server 118. Public internet 114 also provides or receives via HTTP connection 120 information from a dedicated Microsoft Windows system 122 output from polling application 124. Polling application 124 interfaces translator module 126 which receives outgoing messages from outgoing folder 128 that university parking system 130 is an unable to process the screen.

Translator module 126 receives outgoing messages via connection 131 from outgoing folder 128 that university parking system 130 provides. University parking system 130 also receives input via connection 133 as incoming messages information from folder 132. Thus, manual export from university parking system 130 goes to outgoing exports folder 128. University parking system 130 further receives manual import from the incoming imports folder 132.

Note, also, that in one embodiment of the invention, this export function may be automated for a user. Thus, in certain instances it may be necessary to manually import/export from university parking system 130, depending on the software system that the issuing authority may use. In generally, where the issuing authority uses a software system with the proper functionality, the import and export folder may be removed with its functions being part of an adjustable scheduler. There may be other variations of this and other functions in alternative embodiments that squarely fall within the scope of the present invention.

Polling application 112 acts as a stand alone server that has a pre-configured sleep time. The pre-configured sleep time acts as a scheduling interval so that the application can wake up and perform its duties. Moreover, polling application 112 receives process citation data from receiving application 116 and then sends citation data to receiving application 116 for processing. After receiving the citation data from receiving application 116, polling application 112 performs the following tasks. First of all, polling application 112 reads any configuration information from the ‘polling application properties file’. The path to the properties file is set up as a system property during the start up. The polling application uses the ‘traffic payment configuration handler class’ to read the properties files. Moreover, polling application 112 translates the XML citation data into the file format that the university understands and archives the incoming files. Finally, polling application 112 sends an electronic message as an alias upon critical system failures to indicate the existence of such a failure.

The traffic citation settlement system further reads the properties files using traffic payment configuration handling classes. The UML package and class diagrams shown below demonstrate the interaction between various classes. The following illustrates the site interaction that a user may employ. The traffic citation settlement system may use various data constructs and tools for credit card authorizations, settlements and electronic check processing for citation payments. The front end and administration web site development will be utilizing a Java API provided Cybersource. Using these API methods, the site will make external calls to the ICS server via the internet to perform an authorization and bills for a settlement of funds against the traffic payment customer's credit card. When a request is sent to ICS, it is sent over the standard port 80 and is wrapped up in an S-mime message using a public and private key inscription. The traffic citation settlement system uses a set of keys created for their merchant ID and this site will use those keys for all communication to the ICS services.

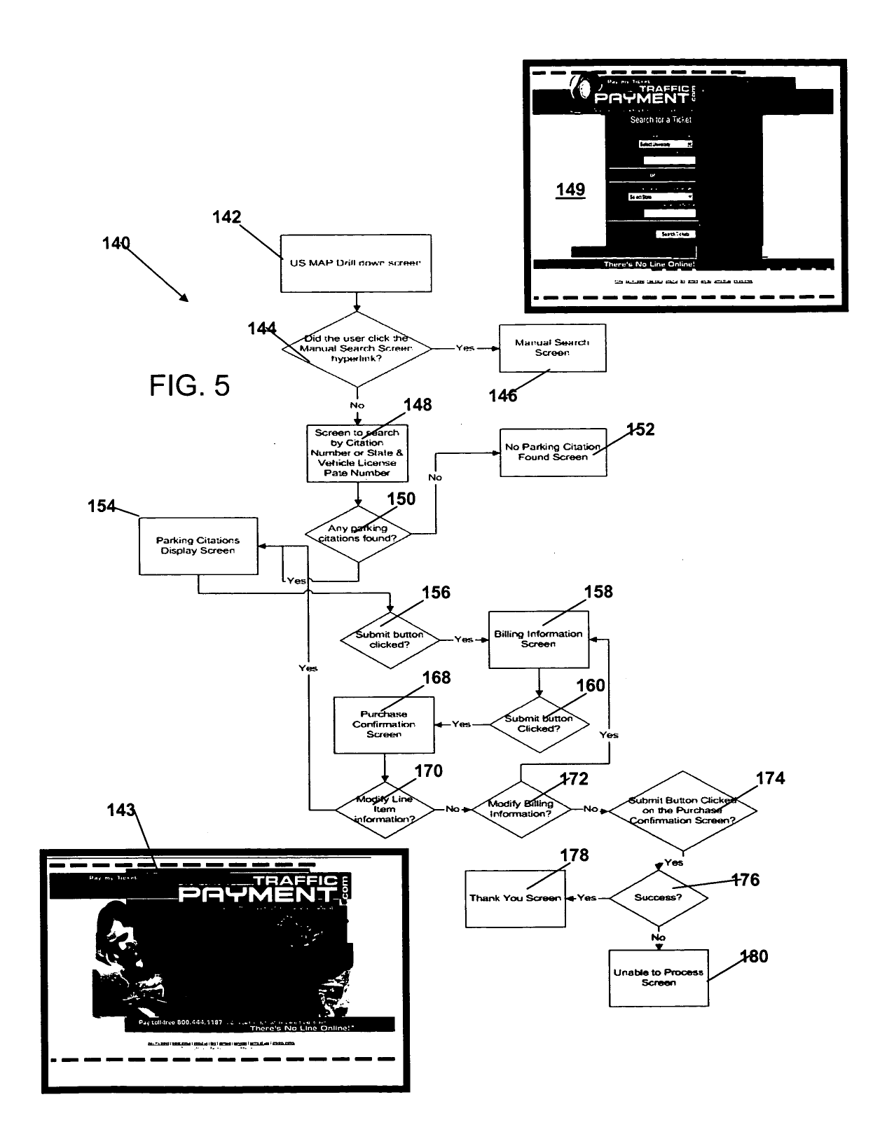

FIGS. 5 through 12 provide flowcharts of the user and administrative functions that the traffic citation settlement system provides. In broad terms, the traffic citation settlement process will use a front end web site whereby a customer may enter the citation number or license plate number to receive a list of citations. If records are found, a screen display for a list of citations with checkboxes against them. The customer may then pick the citations that the customer wishes to pay for by checking the checkboxes associated with the citations. The customer may then enter the credit card billing details and go through a confirmation/invoice screen to verify the details.

If satisfied, the customer would click the ‘submit’ button to have the system of the traffic citation settlement system performing authorization and settlement against the customer's credit card. The traffic citation settlement system will send the purchase information to the ICS authorization and bill services in one request. The ICS system will then take the request and send it to the banking processor that is identified to the appropriate merchant account. If the credit card receives a denial from the banking processor, then the ICS system will not run the ICS bill service and will return the authorization results to the web site. The site will then pass the reply and offer the traffic payment customer the ability to re-enter credit card information one more time.

In the event that a credit card authorization is unsuccessful, the ICS system will then run the ICS bill service which will then batch up the information and place it in the processor's badge to capture the funds from the customer's credit card bank. The ICS system then returns a reply message to the site that includes the authorization response and a request ID for the transaction. A customer may have a maximum of three unsuccessful attempts to pay by credit card, in which case the user is shown a suitable message for an alternative way to pay for citations. If the credit card transaction is successful, the customer is presented with an order confirmation number.

FIG. 5 details the logical flow associated with the traffic citation settlement system. FIG. 5 shows the payment process flowchart 140 which begins at step 142 where a US map drilldown screen is shown to the user. From US map drilldown screen step 142 process flow 142 goes to query 144 where the traffic citation settlement system tests whether the user has clicked the manual search screen 146 hyperlink. If so, process flow 140 goes to step 146, at which point the traffic payment system presents to the user manual search screen 146. Otherwise, process flow 140 continues to step 148, at which point the user views the screen to search by citation number or State and vehicle license plate number. Then, process flow 140 goes to step 150 which queries whether any parking citations have been found. If no parking citations have been found, process flow goes to step 152 where the user is notified that no parking citation is found using a no parking citation found screen. Otherwise, process flow goes to step 154, at which point the user receives a parking citations display screen. If the user clicks the submit button, then at query 156, the process flow is directed to step 158 for the user to view billing information screen 158. Then, process flow 140 goes to query 160 to determine whether the submit button is clicked. If so, process flow 140 goes to purchase confirmation screen 168, which permits the user to modify any line item. If such a modification has occurred, then query 170 examines such causing process flow 140 to return to parking citations display screen 170. Otherwise, process flow 140 goes to query 172 to test whether billing information has been modified. If there is no modification to the billing information, then process flow 140 goes to query 174 to test whether the submit button has been clicked on the purchase confirmation screen 168. If the submit button has been clicked, then process flow 140 continues to success query 176 to determine whether there has been a successful payment of the parking citation. If so, then process flow 140 provides the user “Thank You” screen recognizing the payment of the parking citation. Otherwise, process flow 140 goes to step 180, upon which the user views “Unable to Process Screen.”

As referenced in process flow 140 of FIG. 4, the traffic citation settlement system provides a variety of screens that the user employs for the purpose of traffic payment. A first screen is the United States map drilldown screen 142. This screen presents to system users a clickable United States map to drilldown by state and college or university. United States map drilldown screen 142 further provides a hyperlink to a search for transaction screen of the traffic citation settlement system that enables searching for previously performed transactions according to a confirmation number. In addition, the United States map drilldown screen 142 provides a hyperlink to a manual search screen which allows a user to search by combinations such as, e.g., parking citation number using the college identifier that is passed by a static drilldown function and the (State) and (vehicle license plate) number.

In one embodiment of the traffic citation settlement system a method and system may provide for the hard coding of college locations which may include pointers with hyperlinks and college identifiers on the State map. Thus, when a user clicks a college hyperlink the system will redirect the user to a screen that passes the college identifier. This hyperlink drilldown, which takes place through US map drilldown screen 142, may provide the user with the ability to search by parking citation number or a State and vehicle license plate number. US map drilldown screen 142 may also provide a submit function in a final drilldown whereby the user may search by citation number or state and vehicle license plate number.

The traffic citation settlement system provides a manual search screen 146. manual search screen 146 permits a system user to use dropdown boxes for state, college or university to narrow the search according to the parking citation number. The traffic citation settlement system may further provide the user with dropdown boxes for the user to obtain a college identifier number. Moreover, the traffic citation settlement system may provide for auto population of the college identifier's dropdown box with the local specific collage when a particular state is selected. This may be a Java or similar function. When a user selects a college from a dropdown box, the traffic citation settlement system may enable text boxes to search by parking citation number or State and vehicle license plate number. Moreover, the traffic citation settlement system may also use a scripting language such as JavaScript in providing this functionality.

The traffic citation settlement system may provide a parking citations display screen 154. Parking citations display screen 154 permits the user to view a message indicating whether the user has any current parking violations to pay on-line. The traffic citation settlement system may provide a message to the user that there are no tickets currently available for payment and to check back in a specified amount of time this message could be a part of a Struts applications file.

The traffic citation settlement system may further provide in parking citations display screen 154 a collection of open and appealed parking citations to pay by credit card. A collection of global and university-specific advertisements may also be provided in parking citations display screen 154. The traffic citation settlement system may further provide checkboxes against the parking citations collects provided by the middle tier at the business logic layer. In such an embodiment, the traffic citation settlement system would display global and custom advertisements provided by a middle tier. Each advertisement may be associated with the following attributes of advertiser and identifier, location and name. Based on the advertisement location, the front end screen should derive or obtain the image and display such an image accordingly. Furthermore, parking citations display screen 154 may display college specific global advertisements provided by a middle tier functionality.

The traffic citation settlement system provides billing information display screen 158. In billing information display screen 158, the traffic citation settlement system provides a form with billing details for a credit card payment, as well as fields in which a customer's first and last name, billing address, credit card number, expiration date and other similar information may be input. Such information may further include email addresses, client side validation information, mod 10 check information and labels indicating the information needed for billing a particular traffic ticket.

In purchase confirmation display screen 168, the traffic citation settlement system provides a two-section form to confirm the transaction details. One section of purchase confirmation display screen 168 displays certain line items and a button field to go back to parking citation display screen 154. Another section of purchase confirmation display screen 168 may display the billing details and a button to go back to billing information display screen 158. The traffic citation settlement system may also provide in purchase confirmation display screen 168 the ability to separate the line item details and the billing details into two separate tables that would provide the selection to go back to the appropriate screen for modifications. Such a screen may further provide a pay function to submit the transaction to a service that would authorize and pay the traffic citation.

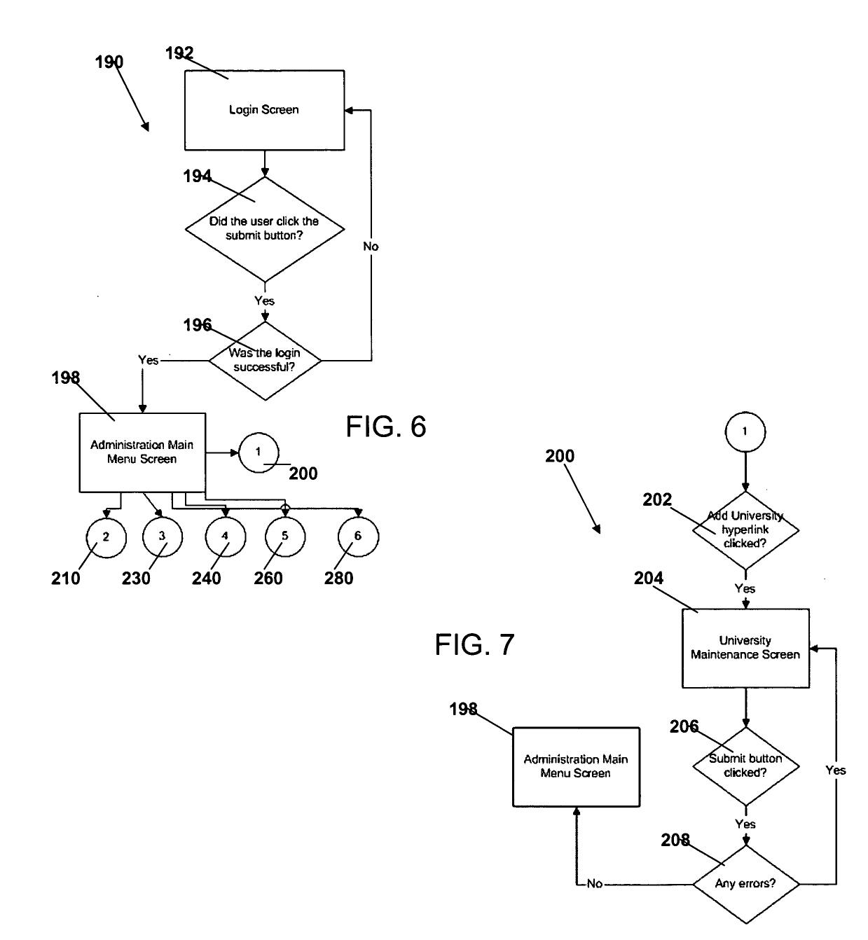

FIG. 6 shows the functions associated with the administration login screen. FIG. 6 shows flowchart 190 for the administrative reporting processes that the preset invention makes possible. Beginning in administrative flowchart 190, the administrator, at step 192, first views an administrative login screen. Then, process flow 190 goes to query 194 to test whether the user clicked the submit button. If so, then process flow 190 goes to query 196 to determine whether the login was successful. If a login is successful, then process flow 190 goes to step 198 where the system of the traffic citation settlement system presents an administration main menu screen. Thereafter, process flow 190 may go to different sub functions as indicated by the sub functions 200, 210, 230, 240, 250, and 280, as described in more detail below.

In the administration login screen the administrator receives or views a login form to enter login details. The elements may include a user identification, a password and then a submit button or function. With the traffic citation settlement system the system may use known security or authentication procedures for the administrative user. This may require a database user access table be created in the traffic payment database for the traffic citation settlement system. The custom code may be written to lookup a user name and password in the database, an action class may use the service interface to perform database lookups. After the initial login, the traffic citation settlement system would forward the user to the administration main menu screen after successful login. If there were a failed login, the traffic citation settlement system would display the appropriate error on the screen.

For the administration of the traffic citation payment process, the traffic citation settlement system allows the administrator to use the login screen to log into the administration web site. If successful, the administrator is redirected to a main menu screen with a series of options. To pay universities, the administrator may browse to the university summary transaction report screen using a hyperlink provided by the main menu screen. The administrator may select the appropriate university from the dropdown and a start date and an end date to search for a list of transactions associated with the university selected.

If records are found the administrator is redirected to the university summary transaction report result screen. This screen displays a summary of transactions performed on behalf of a selected university. The administrator may click the send funds button on this screen to electronically debit the funds to the university's bank account. On the back end, an electronic check debit transaction is sent to the ICS to perform the actual funds transfer. If successful, the administrator is redirected to the administration main menu screen. As such, the system may need to use an intermediate screen to acknowledge the transaction. If unsuccessful, the screen displays the appropriate error message.

The traffic citation settlement system provides many detailed reports that the traffic payment system may use to reconcile with banking statements to ensure that billing requests are settled and that funds were transferred to the appropriate banking accounts. The traffic citation settlement system also provides a database table to store user names and passwords of the respective administrator. In such a system, an administrator may add a university or search a university, as well as add advertisements and search advertisements. Moreover, the administrator may retrieve a report of transaction details relating to a particular university as well as provide a report or a transaction summary relating to a particular university. What follows therefore is information that describes how the traffic citation settlement system provides these features to the administrator.

With reference to FIG. 7, the administration main menu screen presents to the user the ability to perform tasks such as adding a university, searching a university, adding and searching advertisements and obtaining reports of transaction details and transaction summaries at the university level. Moreover, the administration main menu screen provide to the administrator hyperlinks to appropriate screens to perform the involvements in such task.

FIG. 7 shows flowchart 200 of the administrative portion for adding a university to the traffic citation settlement system of the traffic citation settlement system. Thus, from administration main menu screen 198 of FIG. 6, in the event that the add university hyperlink is clicked, query 202 causes process flow to proceed to step 204 where the administrator receives the university maintenance screen. Then process flow goes to step 206 at which point the system tests whether a submit button has been clicked. If so, process flow continues to query 208 to query whether there are any errors. Otherwise, process flow 200 stays at step 204. If there no errors, then process flow returns to administration main menu screen 198. Alternatively, if there are errors, then process flow continues to university maintenance screen 204.

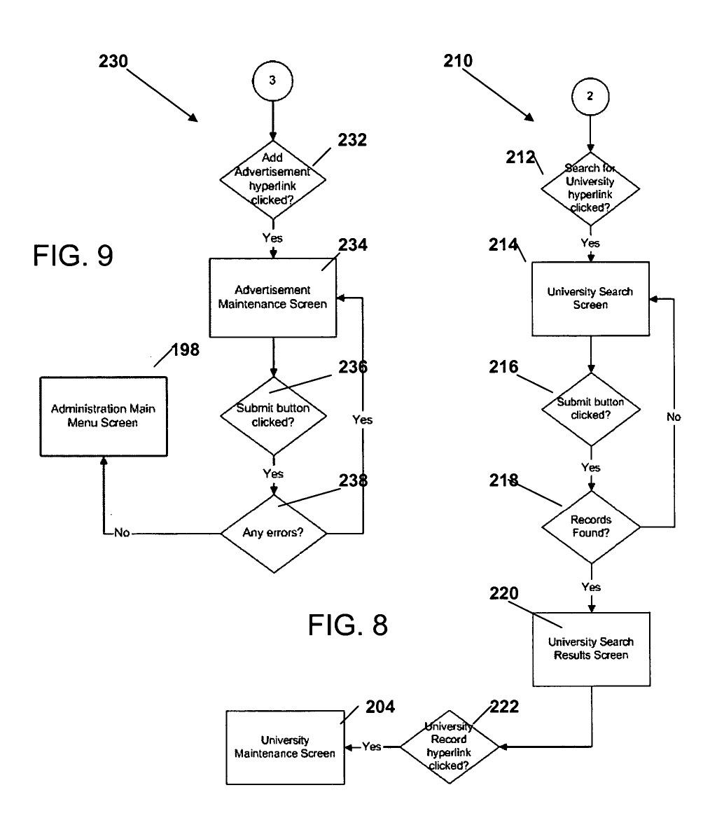

FIG. 8 relates to the university search functions associated with the administration of the traffic citation settlement system of the traffic citation settlement system. The university search function allows the administrator the ability to search for a university according the university name or state, for example. The traffic citation settlement system may further provide the administrator with a form containing elements such as the university identifier textbox, a state dropdown box and a submit button. Furthermore, the university search function may validate the form elements with a scripting language such as JavaScript before HTTP posting. If results are found, this function will redirect or forward to the administrator a university search result screen which has hyperlinks to the university maintenance screen. Each hyperlink may provide a drilldown to the university maintenance screen.

FIG. 8, therefore, shows flowchart 210 that illustrates the logic associated with the operation of the search for university function appearing on administration main menu screen 198. Thus, in flowchart 210 at query 212, the administration program tests whether the search for university hyperlink has been clicked. If so, process flow 210 proceeds to university search screen 214. Then, flowchart 210 continues to query 216 at which point a query of whether the submit button has been clicked occurs. If so, process flow further continues to query 218 to examine whether any records have been found. If not, process flow returns to university search screen 214. Otherwise, process flow proceeds to university search results screen 220. Then, at query 222 process flow 210 tests whether the university record hyperlink has been clicked. If so, process flow returns to university maintenance screen 204.

FIG. 9 shows process flow 230 illustrating the response of the administration process of the traffic citation settlement system relating to the addition of an advertisement. Thus, at query 232 a test occurs as to whether the advertisement hyperlink has been clicked. If so, process flow 230 proceeds to step 234 for directing the administrator to the advertise maintenance screen. Then, at query 236, process flow queries whether the submit button has been clicked. If so, query 238 examines whether there are any errors. If any errors occur, then process flow returns to advertisement maintenance screen 234. Otherwise process flow continues to administration main menu screen 198.

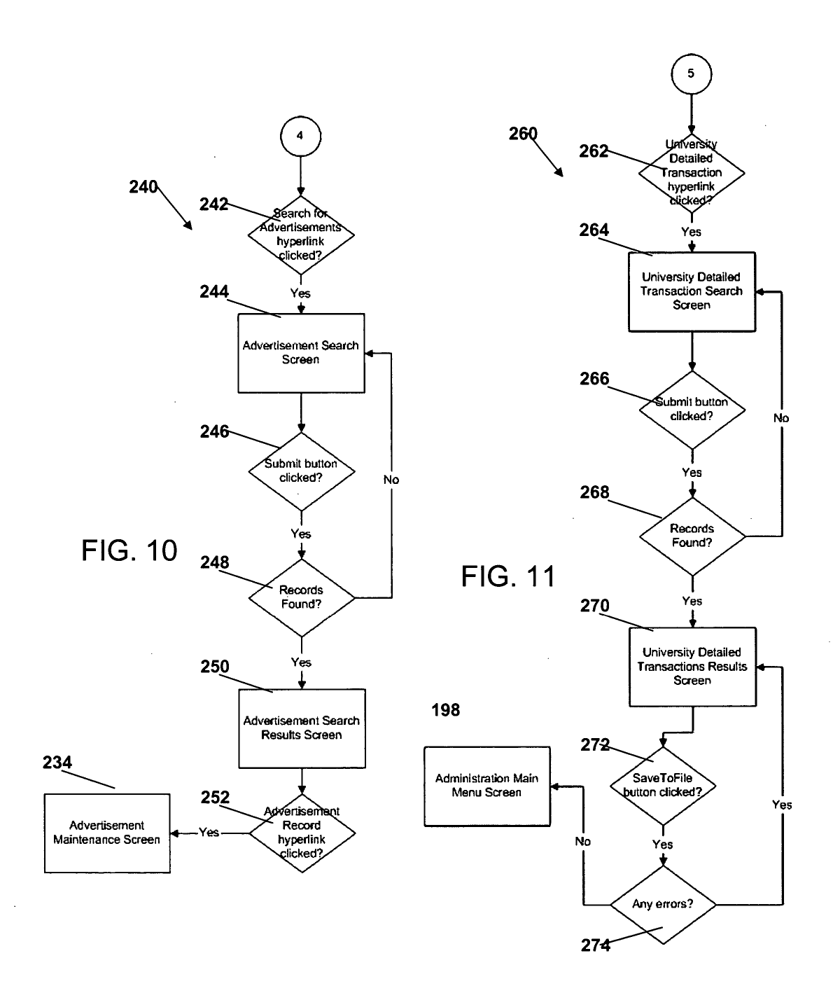

FIG. 10 shows flowchart 240 for the advertisements search results screen of the traffic citation settlement systems. Thus, the screen presents to the system administrator the ability to drilldown and update the active roots of an advertisement associated with the traffic citation settlement system. By clicking a hyperlink presented, this functionality directs the administrator to an advertisements maintenance screen for a particular advertisement. In one embodiment of the traffic citation settlement system, the traffic citation settlement system may provide an ability to navigate to a sample code to get a further understanding. Such an embodiment may also display the following on the screen of each advertising record found in the database according to search criteria relating to a particular hyperlink. In the advertisement maintenance screen the administrator may add a new advertisement to the traffic citation payment system database, as well as update the contents of an existing advertisement, or even associate an existing with a university or other issuing authority.

The traffic citation settlement system may also include for the administrator the ability to use a form that includes the advertisement name, description, and other information relating to the advertiser. In particular, if the advertisement is a customized advertisement, the traffic citation settlement system may perform a JavaScript validation to select only one university before an HTTP posting yet to the processing screen. After HTTP posting the traffic citation settlement system may validate that the advertisement was not previously assigned to the university. If the advertisement is a global advertisement, the traffic citation settlement system may enable the user to select more than one university with which to associate the advertisement. Upon adding a new entity or updating a existing entity the advertiser maintenance screen may permit the administrator before the reader is correct.

FIG. 10, therefore, illustrates process flow 240 of the administration process for search for advertisements. Thus, within process flow 240, query 242 examines whether the search for advertisement hyperlink has been clicked. If so, process flow continues to advertisement search screen 244. Then, process flow goes to submit button clicked query 246. If the submit button has been clicked, process flow continues to query 248 to test whether any records have been found. If no records have been found, then process flow returns to advertisement search screen start 244. If records are found, process flow continues to advertisement search result screen 250. From advertising search result screen 250, process flow continues to advertiser and record hyperlink clicked query 252, which tests if the administrator has clicked an advertisement record hyperlink. If the advertisement record hyperlink has been clicked, process flow further proceeds to advertisement maintenance screen 234.

FIG. 11 depicts the process flow 260 that the traffic citation settlement system performs in response to the administration of a university detailed transaction hyperlink being clicked. In the university detailed transaction search report process flow 260, the administrator has the ability to search for a list of all the detailed transactions by university name, start date, and end date. With the traffic citation settlement system, there may further be the ability to provide to the administrator a form with elements including the university name, start date textbox, end date textbox and a now button 1 each against the start and end date textboxes. The traffic citation settlement system may also allow the administrator to enter the start date and end date as well as validate the start date and end date of a particular transaction. The functionality associated with the university detailed transaction is detailed in FIG. 11.

Referring, therefore, to process flow 260 of FIG. 11, at query 262 there is the test of whether a university detailed transaction hyperlink has been clicked. If so, then process flow continues to step 264, at which process flow 260 presents to the user a university detailed transaction search screen. Then, process flow 260 continues to query 266 for testing whether the submit button has been clicked. If so, then process flow 260 goes to query 268 to test whether there are any found records. That is, records may be found by one of many types of search engines. Otherwise, process flow returns to step 264, again presenting the university detailed transaction screen.

The traffic citation settlement system proceeds when a record is found. At step 270, process flow 260 presents to the user a university detailed transactions results screen. Then, at query 272, process flow 260 tests whether the save to file button has been clicked. If so, then process flow 260 continues to query 274 for further testing for the existence of errors. At step 198, process flow 260 presents to the administrator the administrator main menu screen, in the event that no errors are identified at step 274. Otherwise, process flow returns to university detail transactions results screen 270.

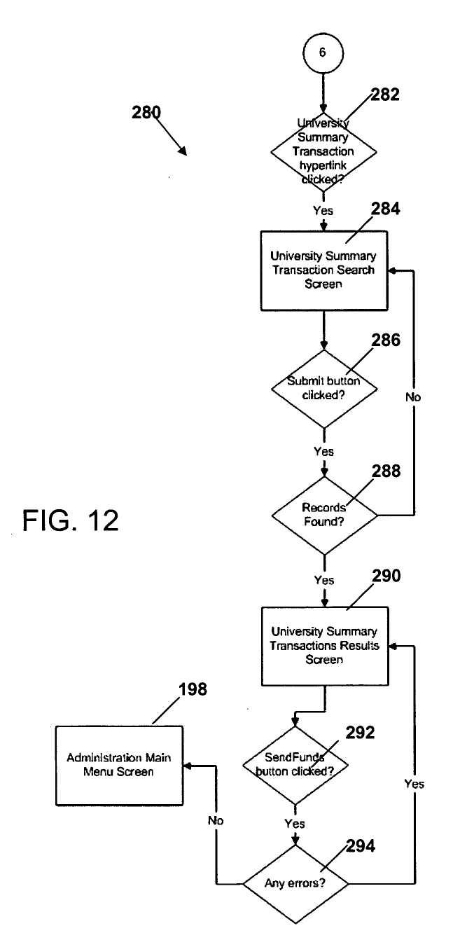

FIG. 12 depicts the process flow 280 of the traffic citation settlement system in response to the administration of a university summary transaction hyperlink being clicked. With the university summary transaction search report, the administrator has the ability to search through a list of all detailed transactions by university name, start date, and end date. Thus, the traffic citation settlement system permits the administrator to build a screen based on the guidelines and including a form having the university name, start date, end date, and different submitting function buttons. In the university summary transaction report, the traffic citation settlement system permits the administrator to enter the start date and end date, as well as to have a JavaScript function behind the “Now” button to put the current date into the start and end date textboxes when clicked.

Referring, therefore, to FIG. 12, process flow 280 begins at query 282, which tests with the University summary transaction hyperlink has been clicked. If so, process flow continues to step 284, at which a university summary transaction search screen appears to the administrator. Then, at query 286, process flow 280 includes testing whether the submit button has been clicked. If so, then process flow continues to step 288 for testing whether records have been found. If a record is found, then process flow continues to step 290 for presenting to the user a university summary transaction results screen. Then, process flow continues to query 292 for testing whether the send funds button has been clicked. If so, then process flow continues to query 244 for testing whether there are any errors. If not, then process flow 280 continues to step 198 for displaying to the user the familiar administrative main menu screen.

FIG. 13 shows an example of the storefront package diagram 300 consistent with the teachings of the traffic citation settlement system. The business objects package 304 provides a collection of classes that represent the various business entities used by the service package. The traffic citation settlement system includes a middle tier storefront and middle tier design and implementation function and features. Package diagram 300 illustrates that traffic payment framework 302 provides input to storefront business objects 304 and the Apache Struts package 306. In response to input from storefront framework 302, Apache Struts package 306 further provides input to storefront business packages 304.

FIG. 14 shows the class diagram 310 for the business object package classes that exist within business objects package 304 of FIG. 13. Thus, classes within business objects package 304 may include input from CitationOrder business object class 306, as well as CitationStagingBusiness Object class 308. UniversityBusinessObject class 310 and StateBusinessObject class 312 further provide input to TrafficPaymentBaseBusinessObject class 304. Furthermore, CountyBusinessObject class 314 and Citation-line Item BusinessObject class 316 feed to TrafficPaymentBase BusinessObject class 304. CitationStagingBusinessObject class 308 further provides input to Citation-lineItemStatus CodeBusinessObject class 318. Also, CitationOrder BusinessObject class 306 provides input to CitationOrderStatus Codes BusinessObject class 320 and receives input from Citation-lineItemBusinessObject class 316, as well as CreditCardDetailsBusiness Object class 322. The class diagram 310 for the business object package 304 further includes AdvertisementBusinessObjects class 324 and CitationConvenience FeeBusinessObject class 326.

The traffic citation settlement system further provides a storefront framework service package for implementing the business delegate design pattern to insulate traffic payments and business objects from the persistence layer. The action classes get access to the business objects via the service layer. These actions are described in more detail below.

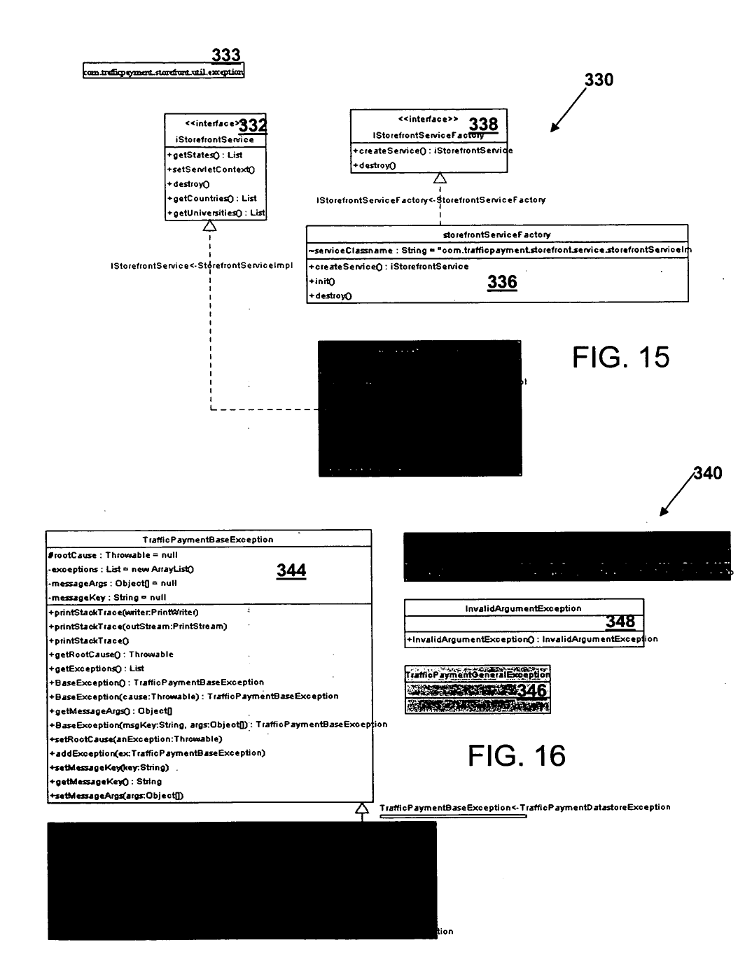

FIG. 15 provides the class diagram 330 of the service package classes according to the teachings of the traffic citation settlement system. In FIG. 15, service package classes 330 include iStorefrontService interface class 332, which associates with StorefrontServiceImpl object 334. Also, StorefrontServiceFactory class 336 provides input to iStorefrontServiceFactory interface 338.

FIG. 16 provides the class diagram 340 for the exceptions package classes according to the teachings of the traffic citation settlement system. Referring to FIG. 16, class diagram 340 includes TrafficPayentBaseException class 344, which receives input from TrafficPaymentDataStore Exception class 342. Associated with class diagram 340 also are TrafficPaymentGeneralException class 346, Invalid ArgurmentException class 348, and TrafficPaymentTransaction Exception class 350.

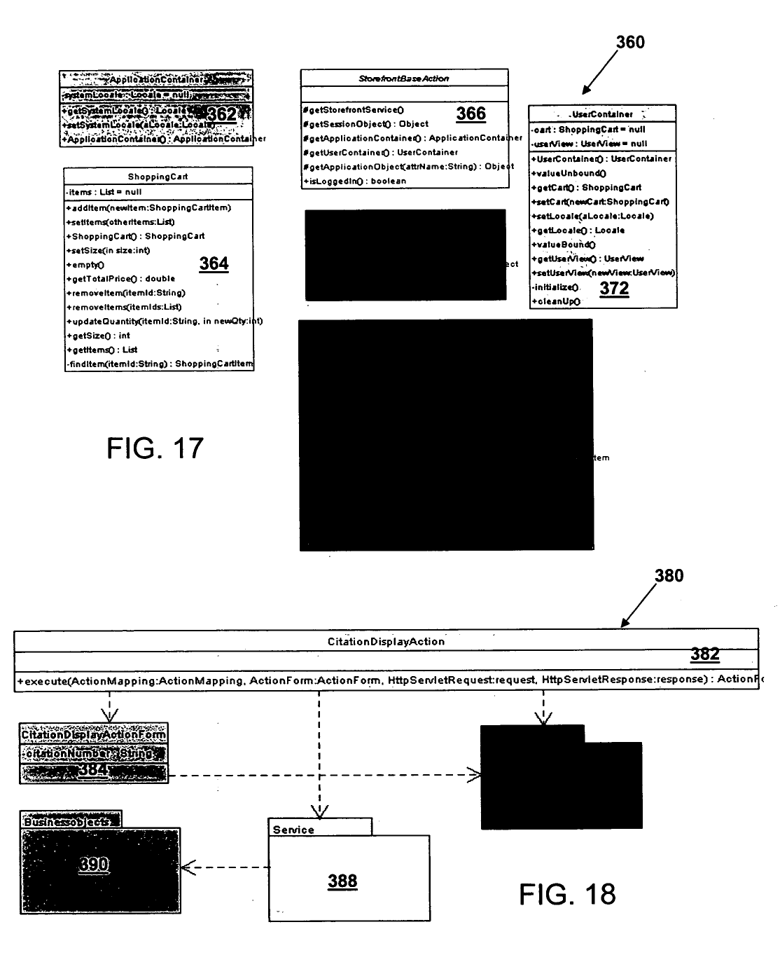

FIG. 17 shows a base framework classes 360 used by the storefront action of the traffic citation settlement system. In this example, the base framework classes 360 include, for example, ApplicationContainer class 362, ShoppingCart class 364, and StorefrontBaseAction class 368. StorefrontBaseAction class 366 and StorefrontDispatchAction 368 also form part of the storefront framework classes 360. Furthermore, ShoppingCartItem class 370 and UserContainer class 372 provide respective portions and contributions to the base framework classes of the traffic citation settlement system.

FIG. 18 shows the classes 380 which form the framework classes that handle the citation display, selection, and processing within the traffic citation settlement system. In this embodiment, the classes shown in FIG. 18 are framework classes 380 used to handle the citation display selection and processing. Thus, CitationDisplayAction class 382 accesses CitationDisplayActionForm class 384 and struts package 386. In addition, CitationDisplayAction class 382 accesses service package 388, which in turn accesses business objects 393.

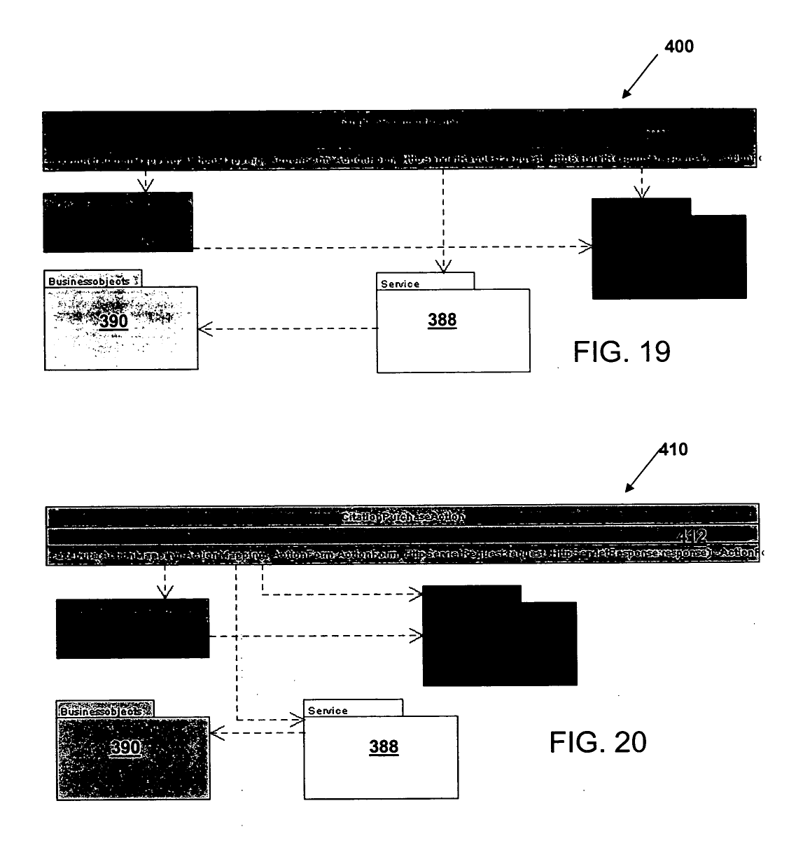

FIG. 19 shows the framework classes 400 of the traffic citation settlement system for handling citation payment information display and processing. In this embodiment, the classes shown in FIG. 19 are framework classes 400 used to handle citation payment and information display processing. FIG. 19 shows the payment package diagrams 400 for the CitationPaymentAction class 402. CitationPaymentAction class 402 provides inputs to CitationPaymentActionForm class 404, as well as provides input to struts package 386, and service package 388. In return, service package 388 provides input to business objects package 390.

FIG. 20 shows the framework classes 410 used to handle the citation purchase information display processing of the traffic citation settlement system. FIG. 20 shows the association for the citation purchase action purchase package 412, which provides input to citation purchase action form 414. This includes, as similar to previously described, input to struts package 386, and service package 388. Service package 388, then further provides input to BusinessObjects package 390.

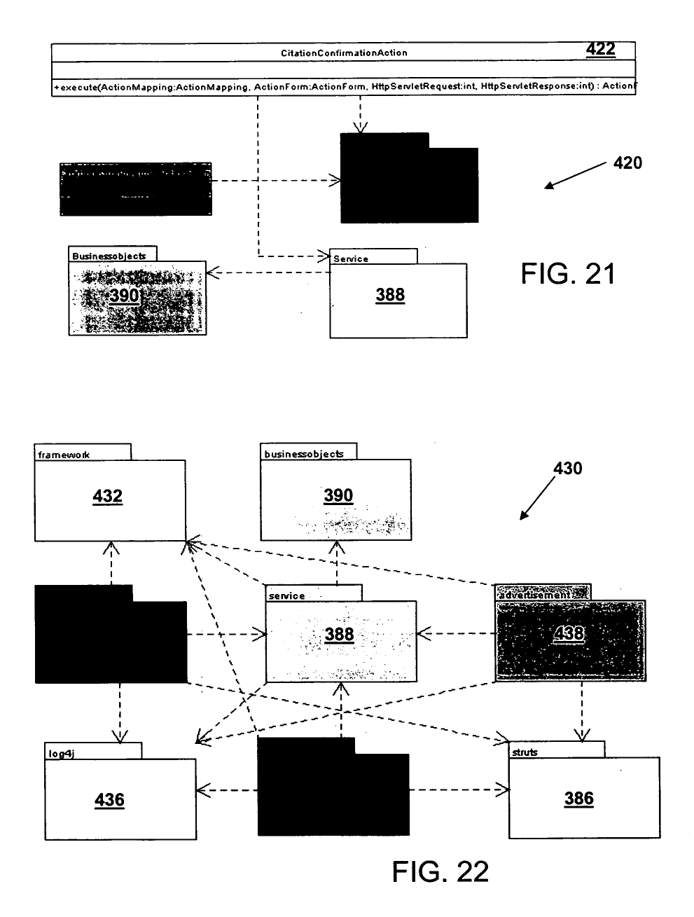

FIG. 21 shows the framework classes 420 that are used to handle citation purchasers confirmation display processing. The traffic citation settlement system provides a traffic payment storefront framework auto-confirmation package. In FIG. 21, purchase confirmation framework 420 includes c.

CitationConfirmAction class 422 which communicates to struts package 386, and service package 388. CitationConfirm ActionForm class 424 communicates directly to struts package 386. Then, service package 388 communicates to business objects 390.

FIG. 22 shows the UML and package and class diagram relationships 430 that support the administration recording requirements of the traffic citation payment system of the traffic citation settlement system. Based on the administration recording requirements for the traffic payment system of the traffic citation settlement system, the traffic citation settlement system provides UML packaging class diagrams to handle user requests. The business objects package 390, of FIG. 22, is a collection of classes that represent the various business entities used by the surface package. In FIG. 22, relationships of administrator package diagram 430 include that the framework 432 receives input from security package 434, which also provides input to service package 388 and lg4j package 436. Service package 388 also receives input from advertisement package 438 and university package 440. Service package 388 provides direct input to business objects package 390. In addition to receiving input from security package 334, framework package 332 receives input from university package 440, service package 388, and advertisement package 338. lg4j package 336 also receives input from service package 388, advertisement package 438 and university package 440. Furthermore, struts package 386 receives input from advertisement package 438, security package 434 and university package 430. To understand further the construction of the packages appearing in FIG. 22, the following diagrams illustrate the contents of the described packages.

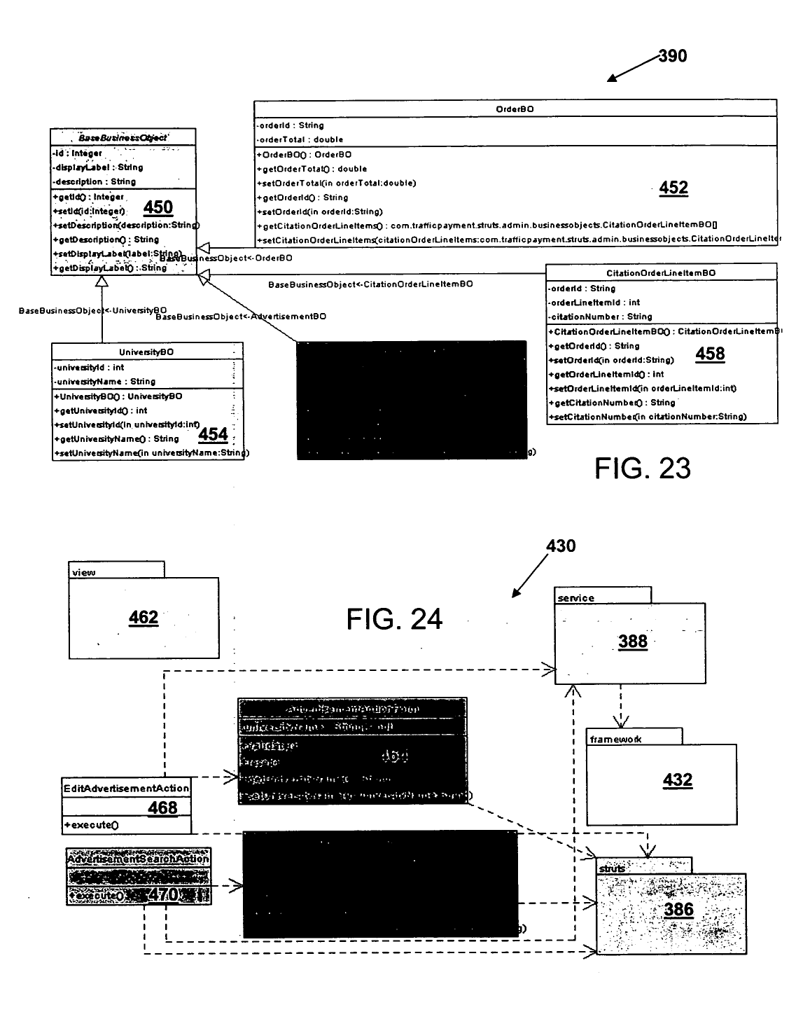

FIG. 23 illustrates the class diagram for the business object package classes. The advertising package is a collection of classes that represent the various advertisement views, action form and action classes. To understand the classes of business objects package 390, FIG. 23 enumerates the exemplary classes. This includes BaseBusinessObjectClass 450 which receives input from OrderBO class 452, UniversityBO class 454, AdvertisementBO class 456 and CitationOrder LineItemBO object 458.

FIG. 24 shows diagram 460 in which the advertisement package classes are associated with other package classes. Packages of relevance to diagram 460 include service package 388, framework package 432, struts package 386, and view package 462. In diagram 460, EditAdvertisement Action class 468 provides input to AdvertisementActionForm 464 and AdvertisementSearchActionForm 464, as well as to service package 388. AdvertismentSearch Action class 470 provides input to AdvertisementSearchActionForm class 464, as well as to service package 388 and struts package 386.

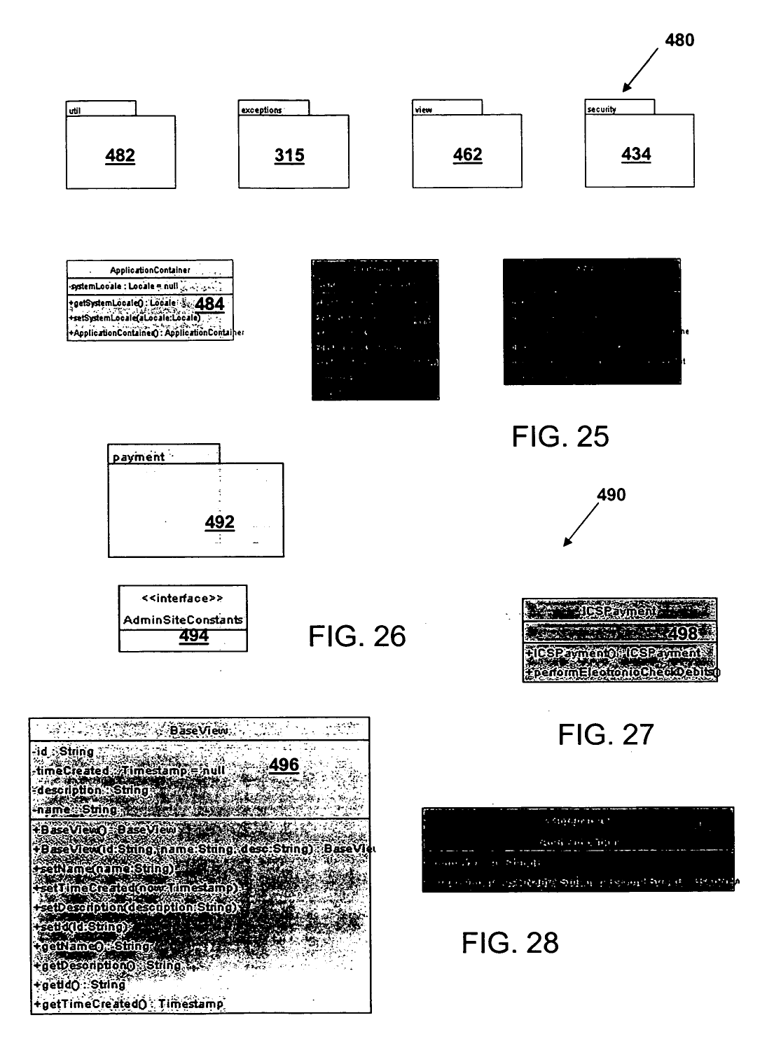

FIG. 25 shows the class diagram for the framework package classes 480. Framework package classes 480 include ApplicationContainer class 484, UserContainer class 486, and AdminSiteBaseAction class 488. Associated with these classes are util package 482, exceptions package 315, view package 462, and security package 464.

FIG. 26 shows the class diagram for the framework utility sub package classes, which includes AdminSiteConstants interface class 494, which interfaces payment package 492. FIG. 27 is the class diagram for the payment sub package, which includes ICSPayment class 498. FIG. 28 includes class diagrams for the framework view sub package classes, which include BaseView class 496 and IAuthentication interface class 500.

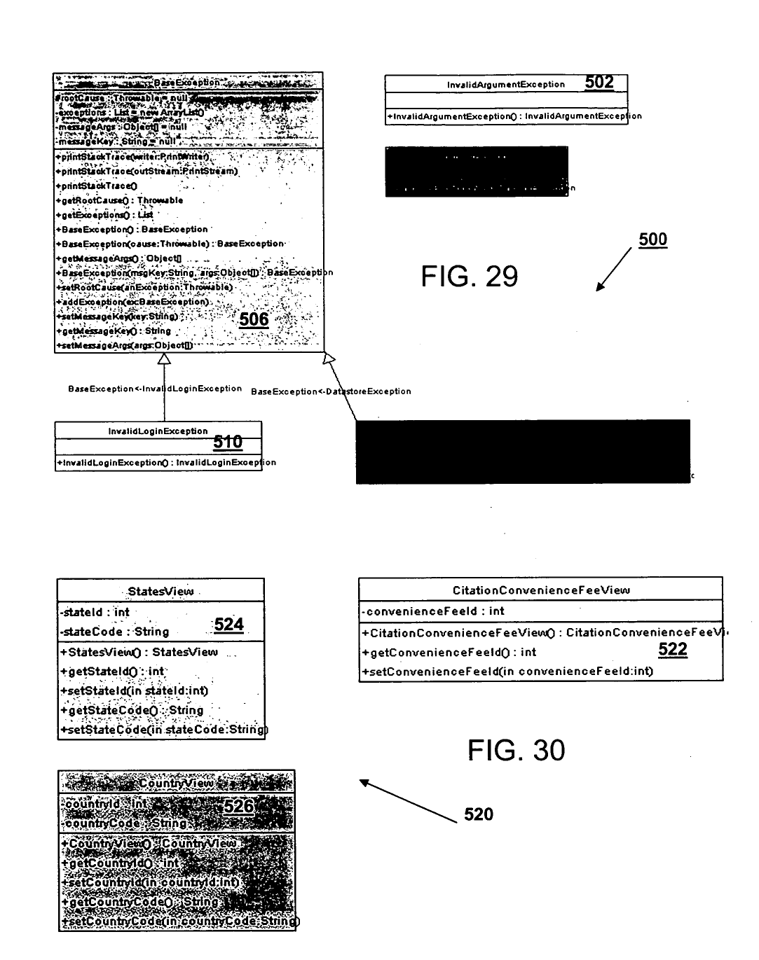

FIG. 29 presents the class diagram for the framework exceptions sub package classes 520. Classes associated as framework exceptions sub package classes 520 include InvalidArgumentException class 502, and Payment Exception class 504. BaseException class 506 receives input form DataStoreException class 508 and InvalidLoginException class 510.

FIG. 30 presents the class diagram for the general package classes 520. These classes include, for example, CitationConvenienceFeeView class 522, StatesView class 524, and CountryView class 526.

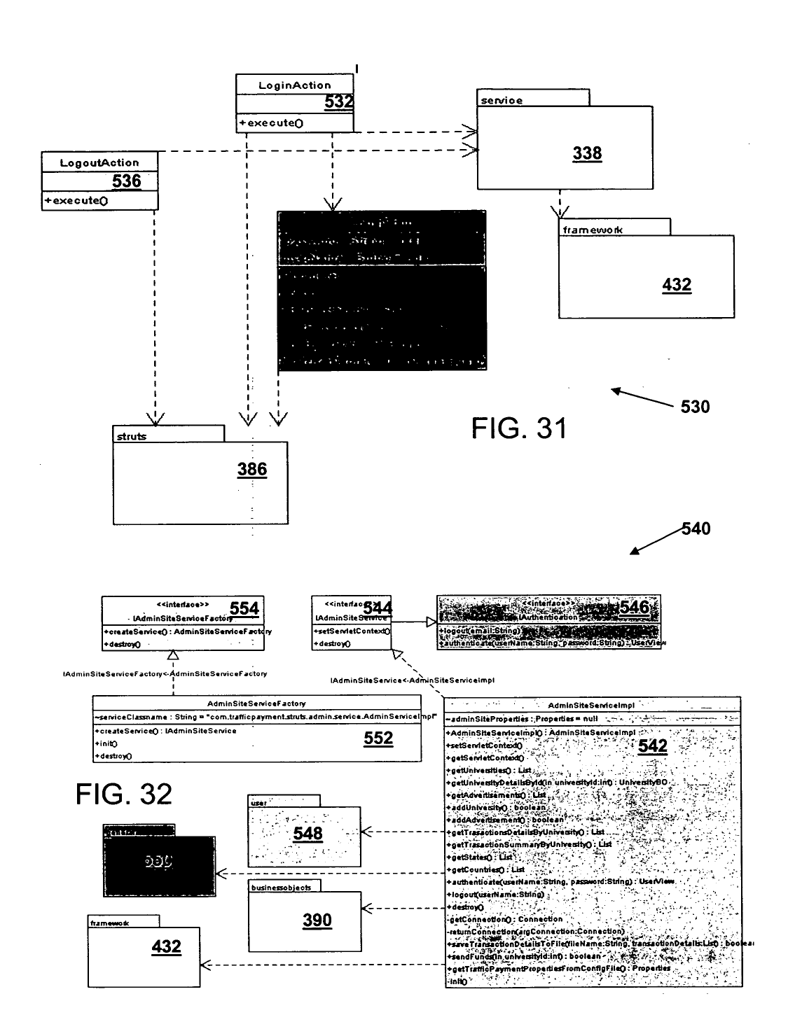

FIG. 31 shows the class diagram for the security package classes 530. Packages associated with security package classes 530 include service package 388, framework package 432, and struts package 386. Classes providing inputs to these classes include LoginAction class 532, LoginForm class 534, and LoginAction class 536.

FIG. 32 includes the various classes in the collection of delegate access design pattern classes 540. Packages receiving input from delegate access design pattern classes 540 include general package 550, framework package 432, user package 548, and businessobjects package 390. These packages receive input from AdminSiteServiceImpl class 542, which also provides input to IAdminSiteService interface class 544, which interface class provides input to IAuthentication class 546. Also associated with delegate access design pattern class 540 is AdminSiteServiceFactory class 552, which provides input to IAdminSiteServiceFactory interface class 544.

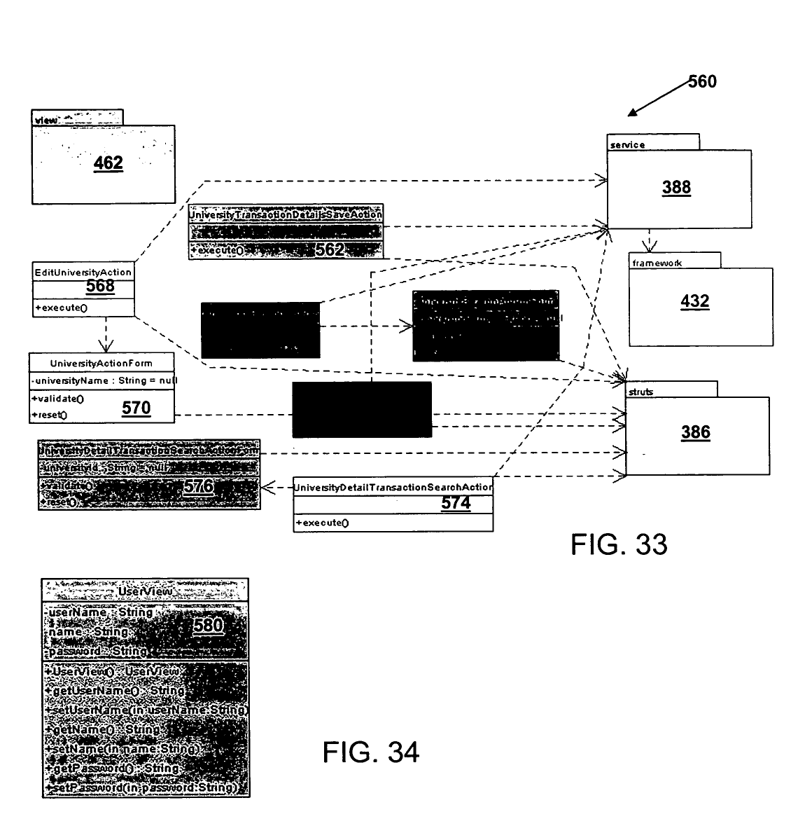

FIG. 33 presents university package classes 560 that demonstrate association with other package classes. The university package is a collection of classes that represent the various university views, action forms and action classes. The class diagrams of FIG. 33 are the university package classes demonstrated association with other package classes for the framework utility sub package classes. These classes include, for example, classes that provide input to service package 388, framework package 432, and struts package 386. View package 462 also associates with university packages classes 560. Such classes include UniversityTransaction DetailSaveAction class 562, UniversitySearchActionForm class 564, UniversitySearchAction class 566, EditUniversityAction class 568, UniversityActionForm class 570, UniversitySendFundsAction class 572, UniversityDetailed TransactionSearchAction class 574, and UniversityDetail TransactionSearchActionForm class.

FIG. 34 shows the class diagram for the traffic payment user package. In FIG. 34, user view class diagram 580 provides for the inclusion of a number of different fields including the user name, the user password, and the user's password.

Accordingly, it is to be understood that the embodiments of the invention herein described are merely illustrative of the application of the principles of the invention. Reference herein to details of the illustrated embodiments is not intended to limit the scope of the claims, which themselves recite those features regarded as essential to the invention.

1. A method for settling a parking citation, comprising the steps of:
providing an on-line parking citation interface to a user;
connecting said on-line parking citation interface to a receiving application for receiving a predetermined minimal set of information relating to a parking citation;
connecting said receiving application to a polling application for interfacing with a parking citation issuing authority;
communicating said predetermined minimal set of information with said parking citation issuing authority in an information protocol usable by said parking citation issuing authority;
identifying a parking citation from said parking citation issuing authority associated with said minimal set of information; and
electronically transferring funds at the direction of the user from a predetermined electronic funds source to an electronic account associated with said parking citation issuing authority for settling said parking citation.

2. The method of claim 1, further comprising the step of directing settlement instructions from the user to a financial institution associated with said electronic funds source for processing approval to electronically transfer funds from said predetermined electronic funds source to said electronic account associated with said parking citation issuing authority.

3. The method of claim 1, further comprising the step of selecting said information protocols from a set of information protocols associated with said polling application.

4. The method of claim 1, further comprising the step of permitting the user to unsuccessfully attempt said step of electronically transferring funds not more than a predetermined number of times.

5. The method of claim 1, further comprising the step of enabling a user to perform credit card processing authorization of credit and debit cards.

6. The method of claim 1, further comprising the step of enabling a user to perform setup of merchant accounts.

7. The method of claim 1, further comprising the step of enabling a user to receive an email settlement receipt and confirmation number.

8. The method of claim 1, further comprising the step of enabling a user to check the status of a ticket on-line.

9. The method of claim 1, further comprising the step of enabling a user the ability to perform no unwanted trips to the parking or municipal office.

10. The method of claim 1, further comprising the step of enabling a user to perform a settlement transaction without the use of a payment envelope.

11. The method of claim 1, further comprising the step of enabling a user to interface a web portal for performing the traffic citation settlement transaction.

12. The method of claim 1, further comprising the step of enabling a user to perform a toll-free call settling the traffic citation settlement transaction.

13. The method of claim 1, further comprising the step of enabling a user to interface to existing parking management software associated with the issuing authority.

14. A system for settling a parking citation, comprising:
instructions for providing an on-line parking citation interface to a user;
instructions for connecting said on-line parking citation interface to a receiving application for receiving a predetermined minimal set of information relating to a parking citation;
instructions for connecting said receiving application to a polling application for interfacing with a parking citation issuing authority;
instructions for communicating said predetermined minimal set of information with said parking citation issuing authority in an information protocol usable by said parking citation issuing authority;
instructions for identifying a parking citation from said parking citation issuing authority associated with said minimal set of information; and
instructions for electronically transferring funds at the direction of the user from a predetermined electronic funds source to an electronic account associated with said parking citation issuing authority for settling said parking citation.

15. The system of claim 14, further comprising the step of directing settlement instructions from the user to a financial institution associated with said electronic funds source for processing approval to electronically transfer funds from said predetermined electronic funds source to said electronic account associated with said parking citation issuing authority.

16. The system of claim 14, further comprising instructions for selecting said information protocols from a set of information protocols associated with said polling application.

17. The system of claim 14, further comprising instructions for permitting the user to unsuccessfully attempt said step of electronically transferring funds not more than a predetermined number of times.

18. The system of claim 14, further comprising instructions for enabling a user to perform credit card processing authorization of credit and debit cards.

19. The system of claim 14, further comprising instructions for enabling a user to perform setup of merchant accounts.

20. The system of claim 14, further comprising instructions for enabling a user to receive an email settlement receipt and confirmation number.

21. The system of claim 14, further comprising instructions for enabling a user to check the status of a ticket on-line.

22. The system of claim 14, further comprising instructions for enabling a user the ability to perform no unwanted trips to the parking or municipal office.

23. The system of claim 14, further comprising instructions for enabling a user to perform a settlement transaction without the use of a payment envelope.

24. The system of claim 14, further comprising instructions for enabling a user to interface a web portal for performing the traffic citation settlement transaction.

25. The system of claim 14, further comprising instructions for enabling a user to perform a toll-free call settling the traffic citation settlement transaction.

26. The system of claim 14, further comprising instructions for enabling a user to interface to existing parking management software associated with the issuing authority.
